(19) United States
(12) Patent Application Publication
(10) Pub. No.: US 2005/0115571 A1
(43) Pub. Date: Jun. 2, 2005

(54) Mouthguard

(76) Inventor: Scott Jacobs, Lakewood, CO (US)

Correspondence Address: Law Offices of John S. Munday, PO BOX 423, Isanti, MN, 55040, US

(21) Appl. No.: 10/727,061

(22) Filed: Dec. 2, 2003

(51) Int. Cl. A61C 5/14

(52) U.S. Cl. 128/859

(57) ABSTRACT

A mouthguard for use by athletes in competition and the like, including a first portion formed from a ethylene vinyl acetate copolymer material and having a teeth engaging shape and having a freezing point of less than 130° F. The first portion is formed into a tray having a generally U-shape with a tab extending out from the tray. The tray has a plurality of holes therein. A second portion formed from a block styrene copolymer is mounted on the first portion such that part of the second portion extends through the plurality of holes in the first portion to lock the two portions together. The second portion is formed from a gel material having sufficient softness to protect the user from damage during use in the athletic competition.

### FIELD OF THE INVENTION

The present invention relates to mouthpieces for insertion in a user's mouth for protection of the user's teeth. More particularly, the invention relates to a mouthguard having a first portion that can be fitted to the user and a second portion providing the cushioning desired.

### BACKGROUND OF THE INVENTION

Current mouthpieces, such as athletic mouthguards, are usually formed from thermoplastic materials and come in a variety of shapes, designs, thicknesses, and sizes. Each is designed to protect a user's teeth against physical shock or blows either directly to the teeth, or against a user's jaws, head, or even the user's body. Such mouthpieces are also designed to ensure the mouthpiece stays in position and prevent bite through of the mouthpiece by the user either during normal use or upon the application of shock or blows. Such mouthpieces also may absorb, attenuate, or deflect such blows to decrease the resultant transmitted force in an attempt to decrease or minimize injury to the user.

A myriad of designs exist which attempt to reduce such injury. Such protection has been afforded by custom fitting and/or by the inclusion of ribs, bosses, chambers, inserts, devices, or by simply increasing the thickness of the mouthpiece thereby increasing its bulk. This increased bulk may also increase tongue and breathing interference with resultant discomfort to the user. Some such mouthpieces are composite designs which increase production costs and may lead to higher failure rates.

One type of mouthpiece may be made in dental offices by vacuum forming a sheet of thermoplastic material over a mold of the patient's upper or lower teeth. An example of such formed mouthpieces is PLAYSAFE™ mouthpieces by Glidewell Laboratories of Newport Beach, Calif. which use from two to three layers of laminated ethylene vinyl acetate (EVA) material to produce four different types of mouthpieces having a total thickness of from 3 mm to 5 mm. However, the PLAYSAFE™ mouthpieces are limited in their level of protection to a range of thicknesses, generally 3 mm to 5 mm, of the EVA material so as not to be uncomfortable or interfere with normal breathing or communication. They are also made of two or more layers of laminated EVA material which increase their cost.

U.S. Pat. No. 1,345,904 to Wishart describes a sponge rubber article and a method of making same. A method of vulcanizing a rubber based composition partially filling a perforated mold is described wherein gas is formed in the composition which results in the formation of cells. The gas in the cells adjacent the outer edges of the composition more readily escape through the perforations of the mold than the gas at the central portion. Thus, the cells are largest at the center of the sponge rubber composition and gradually decrease in size to the outer surface where the cells are extremely small rendering the outer surface relatively smooth. However, the surface of such a sponge rubber composition still has an unacceptably rough surface allowing for bacterial growth and thus is undesirable for use in the mouth. Additionally, since the cells thus created are not uniform throughout the composition, uneven protection against blows in different thicknesses make the material unacceptable for complex structures such as mouthpieces, etc. The required partial filling of complex shape molds increases the difficulty of obtaining satisfactory complex finished structures. Even more importantly, the preferred formula and acceptable substitutes contain toxic compounds and therefore are unacceptable for use in the mouth or other like applications.

U.S. Pat. No. 3,532,091 to Lerman describes a mouthpiece that includes a relatively large closed passage-providing portion containing a fluid, either a liquid or a gas. The passage-providing portion is disposed either adjacent the labial surface of the teeth, between the occlusal surfaces of the upper and lower teeth, or in both positions. The closed fluid passage hydrostatically distributes force exerted at one point thereon over a much greater area, thereby decreasing the detrimental effect of the blow. The fluid filed passages may rupture upon the application of shock against the user's mouth causing the mouthpiece to fail, or they may develop a leak which may not be detected which would decrease its effectiveness unbeknownst to the user. Additionally, the use of liquids, which are incompressible, increases the amount of transmitted force. The use of relatively large fluid passages decrease the structural strength and integrity compared to a like sized device without such passages.

U.S. Pat. No. 4,672,959 to May et al describes a mouthpiece that includes a lens-like brace integrally formed in the outer upstanding portion of the elongated shell and positioned on the outer surface of the anterior teeth for reflecting any blow to the anterior teeth and reducing the shock to the teeth. The May mouthpiece further includes a thickened connecting portion overlying the biting surface of the posterior teeth to help prevent concussion and to lessen the shock to the tempro mandibular joint in the event of a blow to either the jaw or head. Indentations are formed in the thickened connecting portion opposite to the biting surfaces of the user's upper teeth having a size and shape complementary to and for receiving the user's lower teeth to form an occlusal index for positioning the user's lower teeth helping to eliminate the trauma of a blow to the side of the jaw.

U.S. Pat. No. 5,339,832 to Kittelsen et al describes a composite mouthguard having a tough, softenable thermoplastic mouthguard portion with a U-shaped base having upwardly extending inner lingual and outer labial walls. A shock absorbing and attenuating nonsoftening, resilient, low compression, elastomer framework is embedded in the mouthguard portion to absorb, attenuate and dissipate shock forces exerted on the mouthguard. The Kittelsen et al framework includes posterior cushion pads within the posterior portions of a U-shaped base with enlarged portions in the bicuspid and molar regions of the teeth to fit on the bicuspid teeth adjacent the canine teeth and in the area of the first adult molars, respectively. The cushion pads and enlarged portions, inter alia, prohibit the user from biting too deeply into the soft thermoplastic ethylene vinyl acetate (EVA) of the mouthguard portion and assures there is no excessive upward displacement of the anterior portions of the lower mandible. A transition support portion extends forwardly from the posterior cushion pads and connects to an anterior impact brace. The anterior impact brace has rearwardly protruding anterior cushion pads extending through the upward outer labial wall and contact the anterior teeth of the upper jaw to attenuate and dissipate shock exerted thereto. The addition of an embedded nonsoftening, low compression, elastomer framework increases manufacturing costs and complexity. Also, after prolonged use and wear of the mouth protector the framework may become dislodged or exposed to the user's soft tissue. The internal framework may also fracture or break, which could remain undetected until injury results. Any blows directed and/or transmitted to the user's jaw are concentrated through the enlarged portions to the sets of molars and sets of bicuspids. Further protection would require thickening of the mouth protector increasing its bulk.

U.S. Pat. No. 2,630,117 to Coleman describes a multi piece mouth protector for athletes consisting of a soft rubber-like plastic shell and an integral rigid, arcuate palatal piece. The palatal piece imparts rigidity to the shell so that it locks to the upper jaw. The Coleman mouth protector includes a narrow metal band or wire embedded beneath the surface of the plastic shell to anchor the palatal piece to the shell. The plastic shell is preferably made from a transparent rubber-lie thermoplastic resin such as polyethylacrylate or other dental polyacrylate resins. The addition of a rigid palatal piece and the embedded metal band increase not only manufacturing costs and complexity, but also the risk of injury to the user after prolonged use and wear of the mouth protector wherein the rigid palatal piece and/or embedded metal band/wire may become dislodged or exposed to the user's soft tissue. Further protection would require thickening of the mouth protector increasing its bulk.

U.S. Pat. No. 2,643,652 to Cathcart describes a unitary mouth protector designed to improve free and easy mouth breathing and to assure against dislodgment under adverse conditions. The Cathcart mouth protector consists of a U-shaped trough with opposing parallel walls to overlie the inner and outer surfaces of the upper teeth of a user, and a palatal membrane overlying the palate of the user. Opposing, parallel shock absorbing ribs opposite the opposing walls partially overlie the upper portions of the inner and outer surfaces of the user's lower teeth to protect the lower teeth and prevent biting the cheeks or lips. Also, the floor of the Cathcart mouth protector trough gradually increases in thickness from the molars to the incisors to provide further protection to the teeth. The Cathcart mouth protector is formed from a soft flexible material such as soft vellum or pure Pará rubber, elastic resin, soft plastic or the like. Increased protection is provided by increasing the thickness of the trough increasing the discomfort of the user and decreasing a free airway for breathing and speech. Even further protection would require thickening of the mouth protector increasing its bulk and increasing the attendant problems.

Our own patent, U.S. Pat. No. 5,732,715 discloses a mouthpiece formed from at least one sheet of resilient thermoplastic material having a quantity of generally spherically shaped gas pockets dispersed therein. The gas pockets in the sheet of resilient thermoplastic material are formed by a blowing agent. The preferred resilient thermoplastic material is ethylene vinyl acetate and the preferred blowing agent is p, p′-oxybis (benzenesulfonyl hydrazide). This has been effective as a safety mouthguard and has achieved good commercial success.

In some instances, the mouthguard can be fitted to the individual, such as by use of a thermoplastic that softens in a warm environment such as a warm water bath, so that it conforms to the shape of the specific user's jaw or teeth. While this is a benefit, such thermoplastics are not always adequately resistant to impact and do not always absorb all the force of a hard blow to the face or jaw, as might accidentally happen in athletic competition.

Accordingly, it is an advantage of the present invention to provide a mouthguard that is conformable to the user's jaw or teeth.

Another advantage of the present invention is to provide a mouthguard that has greater shock absorbing capability than thermoplastics that are heat softened.

Other advantages will appear hereinafter.

### SUMMARY OF THE INVENTION

It has now been discovered that the above and other objects of the present invention may be accomplished in the following manner. Specifically, the present invention provides a mouthguard with a first portion formed from a material that softens at slightly elevated temperatures and a second portion formed from a shock absorbing gel material. Typically the mouthguard is placed in warm water to soften the thermoplastic component, then inserted into the mouth to have the hollow portion of the U-shaped device contact the upper teeth, thus placing the shock absorbing gel material facing down toward the lower jaw and teeth. The gel portion covers the teeth where impact is most likely, namely between the molars and in front of the incisors for maximum protection.

The first portion of the present invention is formed from an inert, flexible plastic such as polyethylene, polypropylene, ethylene vinyl acetate and the like. Any conventional plastic or other material normally used in dental treatments, particularly those formed into trays or other mouthpieces, may be used in this invention.

The second portion of the present invention may be formed from any hygienically safe thermoplastic elastomer or gel that produces a cushioning effect when compressed. It is this second portion that protects the user, while the first portion holds the mouthguard in place.

### BRIEF DESCRIPTION OF THE DRAWINGS

For a more complete understanding of the invention, reference is hereby made to the drawings, in which:

FIG. 1 is a plan view of the preferred embodiment of the present invention;

FIG. 2 is a sectional view taken along line A-A in FIG. 1; and

FIG. 3 is a sectional view taken along line B-B in FIG. 1.

### DETAILED DESCRIPTION OF THE INVENTION

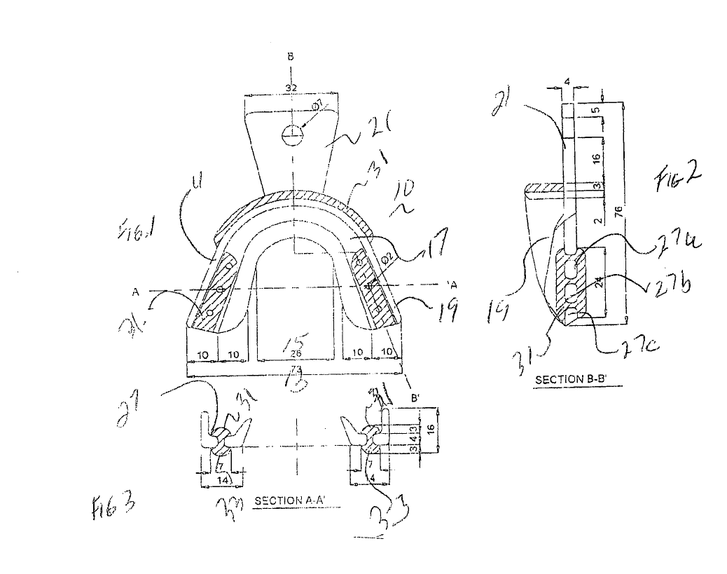

As shown in the drawings, a mouthguard in accordance with the invention, generally shown as 10, includes a first portion 11, which is generally U-shaped and can be adjusted to make the device larger or smaller along dimension 13 as needed to fit the intended user. It is also contemplated that different sizes may be made such that dimension 15 may be different, so the combination of two lengths 13 and 15 will be suitable for smaller and larger athletes and other users. U-shaped first or tray portion 11 includes a base 17, sides, 19 and a tab 21 to assist in insertion of the mouthguard. Located in base 17 are a plurality of holes 27. FIG. 2 illustrates holes 27a, 27b and 27c along the right side of first portion 11 in FIG. 1. First portion 11 is molded by injection molding or other conventional thermoplastic processing techniques, such as through a central tab cavity that forms tab 21.

After molding first portion 11, it is placed in a second mold and that second mold is injected with a gel material. The second or gel portion 31 is located where impact is most likely, namely between the molars and in front of the incisors for maximum protection. Because tray portion 11, a thermoplastic material, and the second portion is a gel, the two materials do not conveniently bond together to form a unitary device. Holes 27 are positioned to receive some of the gel 33 as it is molded on to the base 17, as seen in FIG. 3. The gel 33 is soft and functions as a cushion but has sufficient tensile strength and tear strength to hold the two parts together, particularly when the first or tray portion is softened in warm water to permit the user to fit the device to his or her individual needs.

Upon initial use, the mouthpiece is reheated, preferably in warm water, to soften the first portion of the mouthpiece. The heated mouthpiece is quickly placed onto a user's teeth, again preferably against the upper teeth. The user applies suction between the jaw and mouthpiece to remove the excess moisture and air from between the mouthpiece and the teeth while gently biting down to form teeth indentations on the first portion of the mouthpiece, thus personalizing it to the user's specific needs. Once the mouthpiece cools, the teeth indentations remain, creating a custom fitting mouthpiece.

The material from which the first portion in made requires that it be inert to the patient, and that it have a sufficiently low softening point that it can be conformed to the user's teeth after warming it. The preferred thermopolymer of this invention may be formed from a variety of the commercially available copolymers of ethylene and vinyl acetate, preferably where the percent by weight vinyl acetate is at least 25% by weight. Most preferred are copolymers of ethylene and vinyl acetate in which the percent by weight vinyl acetate is between 25% and 55% by weight. Similarly, the ethylene vinyl acetate copolymer should have a freezing point at which it is not deformable of less than 130° F., and preferably less than about 98.6° F. Most preferred is a commercially available product called DuPont #240 Elvax® ethylene vinyl acetate.

Preferred for the second portion of the device are gels such as styrene block copolymers and thermoplastic polyurethanes, with styrene block copolymers most preferred. The preferred thermoplastic is a clear gel available under the trade name Versaflex CL2000, which is manufactured by GLS Corporation. Versaflex CL2000 has a hardness of 30 on the Shore 00 scale and a specific gravity of about 0.87. The molded gel has an ultimate tensile strength of 250 psi and a tear strength of 50 psi, according to the manufacturer's specifications. This gel is sufficiently strong to remain attached to the base as described above.

While particular embodiments of the present invention have been illustrated and described, it is not intended to limit the invention, except as defined by the following claims.

1. A mouthguard for use by athletes in competition and the like, comprising:
a first outer portion having a teeth engaging shape made from a material having a freezing point of less than 130° F. such that it is capable of conforming to the user's teeth after warming, said first portion being formed into a tray having a generally U-shape, said first portion having a tab extending out from the tray, said tray having a plurality of holes therein;
a second inner portion formed on said first portion such that part of said second portion extends through said plurality of holes in said first portion to lock the two portions together, said second portion being formed from a gel material having sufficient softness to protect the user from damage during use in said athletic competition by producing a cushioning effect when compressed upon contact on the user during use.

2. The mouthguard of claim 1, wherein said first portion is formed from a thermoplastic material.

3. The mouthguard of claim 2, wherein said thermoplastic material is an ethylene vinyl acetate copolymer.

4. The mouthguard of claim 3, wherein said ethylene vinyl acetate copolymer has a freezing temperature of about 98.6° F.

5. The mouthguard of claim 4, wherein said second portion is formed from a gel selected from the group consisting of styrene block copolymers and thermoplastic polyurethanes.

6. The mouthguard of claim 4, wherein said gel is a styrene block copolymer.

7. A mouthguard for use by athletes in competition and the like, comprising:
first outer portion means for engaging teeth and made from a material having a freezing point of less than 130° F. such that it is capable of conforming to the user's teeth after warming, said first portion means being formed into a tray having a generally U-shape, said first portion means having a tab extending out from the tray, said tray having a plurality of holes therein;
second inner portion means for providing a cushion and formed on said first portion means such that part of said second portion means extends through said plurality of holes in said first portion means to lock the two portion means s together, said second portion means being formed from a gel material having sufficient softness to protect the user from damage during use in said athletic competition by producing a cushioning effect when compressed upon contact on the user during use.

8. The mouthguard of claim 7, wherein said first portion means is formed from a thermoplastic material.

9. The mouthguard of claim 8, wherein said thermoplastic material is an ethylene vinyl acetate copolymer.

10. The mouthguard of claim 9, wherein said ethylene vinyl acetate copolymer has a freezing temperature of about 98.6° F.

11. The mouthguard of claim 10, wherein said second portion means is formed from a gel selected from the group consisting of styrene block copolymers and thermoplastic polyurethanes.

12. The mouthguard of claim 11, wherein said gel is a styrene block copolymer.

13. A mouthguard for use by athletes in competition and the like, comprising:
a first outer portion formed from a ethylene vinyl acetate copolymer material and having a teeth engaging shape and having a freezing point of less than 130° F. such that it is capable of conforming to the user's teeth after warming, said first portion being formed into a tray having a generally U-shape, said first portion having a tab extending out from the tray, said tray having a plurality of holes therein;
a second inner portion formed from a block styrene copolymer and mounted on said first portion such that part of said second portion extends through said plurality of holes in said first portion to lock the two portions together, said second portion being formed from a gel material having sufficient softness to protect the user from damage during use in said athletic competition by producing a cushioning effect when compressed upon contact on the user during use.

14. The mouthguard of claim 13, wherein said ethylene vinyl acetate copolymer has a freezing temperature of about 98.6° F.
